(19) United States
(12) Patent Application Publication
(10) Pub. No.: US 2025/0321860 A1
(43) Pub. Date: Oct. 16, 2025

(54) LANGUAGE MODELS FOR GENERATING BUG LOCALIZATION EXPLANATIONS ENHANCED BY CODE SUMMARIZATION

(71) Applicant: Oracle International Corporation, Redwood Shores, CA (US)

(72) Inventors: Dai NGUYEN, Brisbane (AU); Mahinthan CHANDRAMOHAN, Brisbane (AU); Padmanabhan KRISHNAN, Brisbane (AU)

(73) Assignee: Oracle International Corporation, Redwood Shores, CA (US)

(21) Appl. No.: 18/814,452

(22) Filed: Aug. 23, 2024

Related U.S. Application Data
(60) Provisional application No. 63/633,639, filed on Apr. 12, 2024.

(51) Int. Cl. G06F 11/36; G06F 40/284

(52) U.S. Cl. CPC G06F 11/362; G06F 40/284

(57) ABSTRACT

A method implements the use of large language models to generate bug localization explanations enhanced by code summarization. The method includes executing an explanation similarity model using a training report and a training explanation to generate an explanation score for an explanation sample. The method further includes filtering multiple explanation samples using multiple explanation scores to generate a set of filtered explanation samples. The method further includes executing a summarization similarity model using source code and a description to generate a summarization score for a summarization sample including the source code and the description. The method further includes filtering multiple summarization samples using multiple summarization scores to generate a set of filtered summarization samples. The method further includes training a language model using the set of filtered explanation samples and the set of filtered summarization samples to generate a fine-tuned model.

### CROSS REFERENCE TO RELATED APPLICATIONS

This application is a non-provisional application of, and thereby claims benefit to, U.S. Patent Application Ser. No. 63/633,639 filed on Apr. 12, 2024. U.S. Patent Application Ser. No. 63/633,639 is incorporated herein by reference in its entirety.

### BACKGROUND

Machine learning models including pre-trained large language models such as UniXcoder (which may be referred to as language models) may be utilized to gain improvement for many programming language (PL) prediction and classification tasks. Since machine learning-based models are not easy to analyze and are used mainly as black boxes, explainability may be challenging. Explainability enables the user to understand and reason why language models made certain predictions. Due to the large size and high computational complexity of machine learning models, it is a challenge to generate natural language explanations for why code may be correlated with a report of a bug.

### SUMMARY

In general, in one or more aspects, the disclosure relates to a method implementing the use of large language models to generate bug localization explanations enhanced by code summarization. The method includes executing an explanation similarity model using a training report and a training explanation to generate an explanation score for an explanation sample including the training report, training revised code, and the training explanation. The method further includes filtering multiple explanation samples using multiple explanation scores to generate a set of filtered explanation samples. The explanation samples include the explanation sample and the explanation scores include the explanation score. The method further includes executing a summarization similarity model using source code and a description to generate a summarization score for a summarization sample including the source code and the description. The method further includes filtering multiple summarization samples using multiple summarization scores to generate a set of filtered summarization samples. The summarization samples include the summarization sample and the summarization scores include the summarization score. The method further includes training a language model using the set of filtered explanation samples and the set of filtered summarization samples to generate a fine-tuned model. The set of filtered explanation samples include the explanation sample including the training report, the training revised code, and the training explanation.

In general, in one or more aspects, the disclosure relates to a system that includes at least one processor and an application that executes on the at least one processor. Executing the application performs executing an explanation similarity model using a training report and a training explanation to generate an explanation score for an explanation sample including the training report, training revised code, and the training explanation. Executing the application performs filtering multiple explanation samples using multiple explanation scores to generate a set of filtered explanation samples. The explanation samples include the explanation sample and the explanation scores include the explanation score. Executing the application performs executing a summarization similarity model using source code and a description to generate a summarization score for a summarization sample including the source code and the description. Executing the application performs filtering multiple summarization samples using multiple summarization scores to generate a set of filtered summarization samples. The summarization samples include the summarization sample and the summarization scores include the summarization score. Executing the application performs training a language model using the set of filtered explanation samples and the set of filtered summarization samples to generate a fine-tuned model. The set of filtered explanation samples include the explanation sample including the training report, the training revised code, and the training explanation.

In general, in one or more aspects, the disclosure relates to a non-transitory computer readable medium including instructions executable by at least one processor. Executing the instructions performs executing an explanation similarity model using a training report and a training explanation to generate an explanation score for an explanation sample including the training report, training revised code, and the training explanation. Executing the instructions performs filtering multiple explanation samples using multiple explanation scores to generate a set of filtered explanation samples. The explanation samples include the explanation sample and the explanation scores include the explanation score. Executing the instructions performs executing a summarization similarity model using source code and a description to generate a summarization score for a summarization sample including the source code and the description. Executing the instructions performs filtering multiple summarization samples using multiple summarization scores to generate a set of filtered summarization samples. The summarization samples include the summarization sample and the summarization scores include the summarization score. Executing the instructions performs training a language model using the set of filtered explanation samples and the set of filtered summarization samples to generate the fine-tuned model. The set of filtered explanation samples include the explanation sample including the training report, the training revised code, and the training explanation.

Other aspects of one or more embodiments may be apparent from the following description and the appended claims.

### BRIEF DESCRIPTION OF DRAWINGS

FIG. 1, FIG. 2, FIG. 3, FIG. 4A, and FIG. 4B show diagrams in accordance with the disclosure.

FIG. 5 shows a method in accordance with the disclosure.

FIG. 6 and FIG. 7 show examples in accordance with the disclosure.

FIG. 8A and FIG. 8B show computing systems in accordance with the disclosure.

Similar elements in the various figures are denoted by similar names and reference numerals. The features and elements described in one figure may extend to similarly named features and elements in different figures.

### DETAILED DESCRIPTION

Embodiments of the disclosure implement systems using large language models to generate bug localization explanations enhanced by code summarization. To generate the explanations enhanced by code summarization, a language model (which may be a pre-trained language model) may be fine-tuned with multi-task learning for both bug localization explanation and code summarization tasks. The fine-tuning process utilizes high-quality samples (referred to as samples) for explanations and summarization. The explanation samples are selected by analyzing previously resolved reports by comparing the reports to an explanation. The summarization samples are selected by analyzing and comparing code and the descriptions of the code. As a result, the fine-tuned model may better understand the methods, functions, etc., within source code to generate better explanations. After fine-tuning a pre-trained model with the high-quality samples, the fine-tuned model may be prompted with a report and code to generate an explanation.

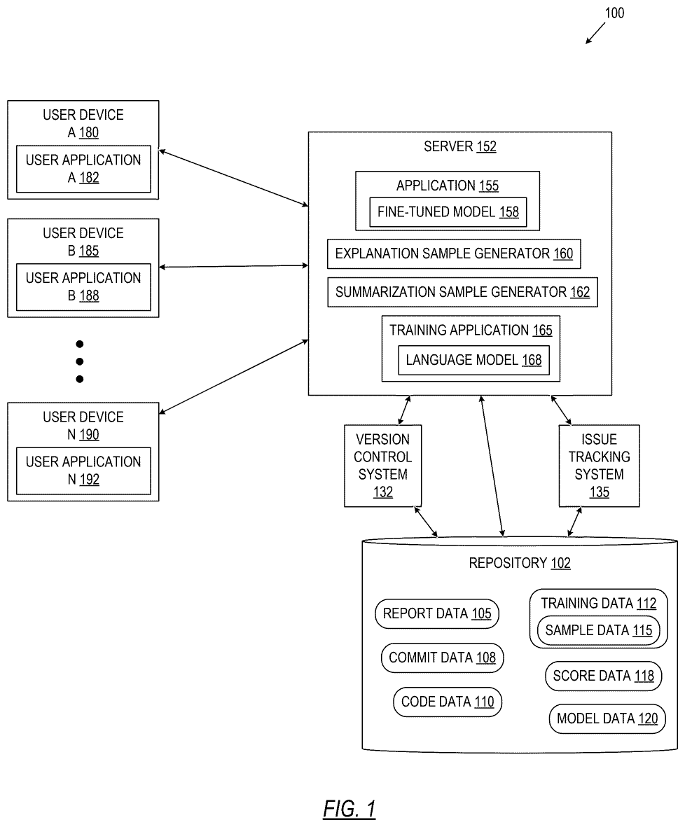

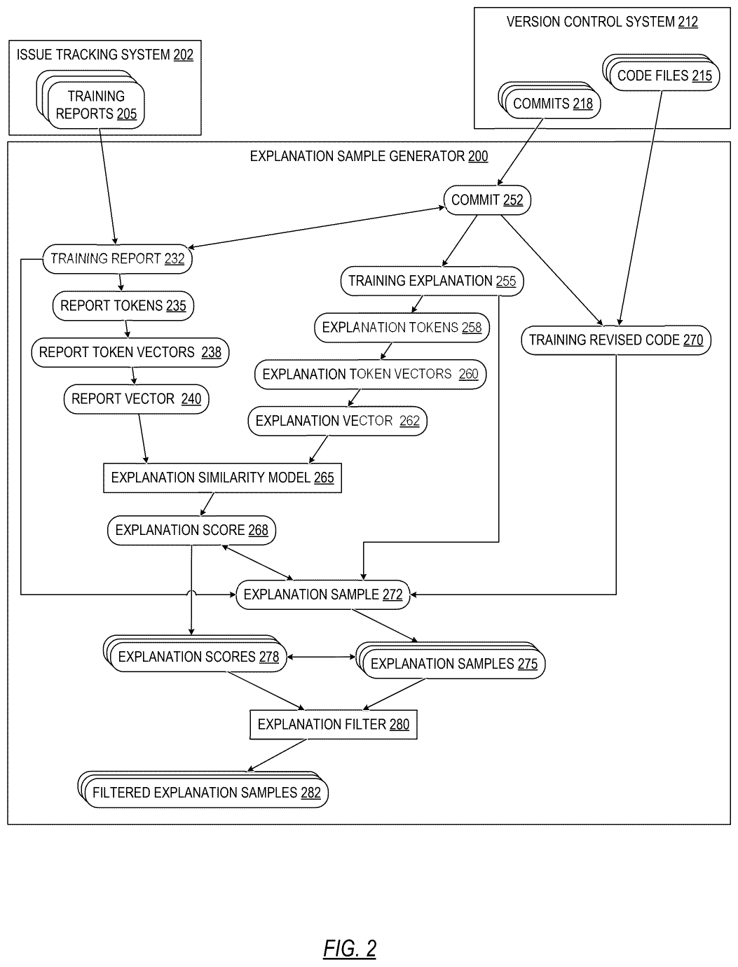

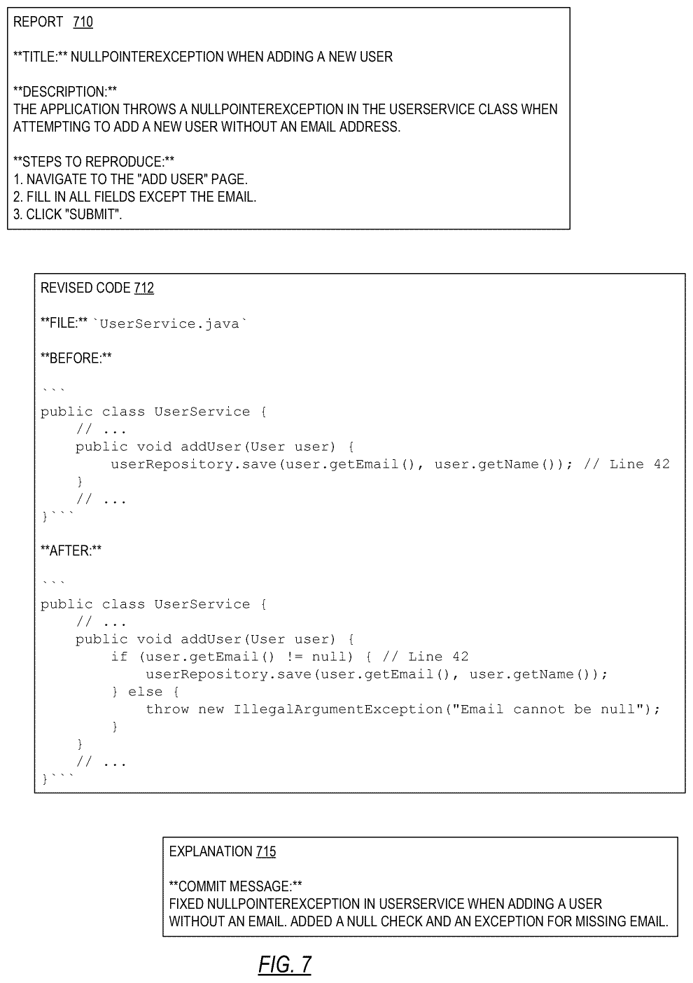

Turning to FIG. 1, the system (100) is a computing system that operates to use large language models to generate bug localization explanations enhanced by code summarization. The components of the system (100) may each include one or more processors and one or more memories with data and instructions in accordance with the computing systems described in FIG. 7A and FIG. 7B. The processors load data and instructions from the memories into registers of the processors, process the data in the registers in accordance with the instructions, and store results in the registers back to the memories. The system (100) includes the server (152) that communicates with the repository (102) and the user devices A (180) and B (185) through N (190).

The repository (102) is a collection of storage devices (e.g., file systems, databases, data structures, etc.) that store and maintain the data used by the system (100). The repository (102) may include multiple different, potentially heterogenous, storage devices. The repository (102) stores data utilized by other components of the system (100). The data stored by the repository (102) includes the report data (105), the commit data (108), the code data (110), the training data (112), the sample data (115), the score data (118), and the model data (120).

The report data (105) is a collection of data that includes the data structures used to store the reports processed by the system (100). As an example, each report may be stored in a data structure, which may be a file in a file system or a record in a database.

A report, in the report data (105), may be a report of a bug being tracked with the issue tracking system (135). A bug is a flaw or error in a software program (e.g., in the code data (110)) that causes unexpected behavior or incorrect results.

A report is a collection of information, e.g., text, that describes an issue (e.g., a bug). A report may include sections for a title, a description, and steps to reproduce, which may be stored in different fields of a database. The title provides a short description of the issue. The description provides additional details of the issue, to identify applications, operating systems, computing platforms, etc. related to the issue. The steps to reproduce are the actions to take to reproduce the issue. Additional types of information may be included, which may be stored in different fields.

The commit data (108) is information associated with the commits of the version control system (132). Commits are snapshots of the code data (110) of the repository (102) at a particular point in time. A commit may include a commit identifier, author information, a timestamp, a commit message, code changes, etc. The commit identifier uniquely identifies one commit from other commits and may be an integer value. The author information identifies the author of the commit, may include legal names, e-mail addresses, etc., to identify one author from each of the other authors that submit commits to the issue tracking system (135). The timestamp identifies when the commit was submitted and may include date (day, month, year, etc.) and time (hour, minute, second, etc.) information. The commit message may be text generated by the author that explains the changes that were made and the reasoning behind the changes. The code changes identify the changes made to the programming language code that updates the code data (110).

The code data (110) is programming language code managed by the version control system (132). The programming language code is a set of instructions written in a programming language that a computer may execute. Programming languages include Python, JavaScript, Java, C++, assembly language, binary language, etc. Code written in a high-level language may be compiled to code in low level languages or binary code that is executable by computing system. The code data (110) may include a file system that stores multiple coding projects within multiple files and directories.

The training data (112) is data used to train the models of the system, including the language model (168). In an embodiment, the training data (112) may include inputs and labels for the inputs. The labels may identify the expected outputs for a given input. The training data (112) includes the sample data (115).

The sample data (115) is a collection of high-quality samples for training the language model (168). The sample data (115), when used to train the language model (168), fine-tunes the language model (168) to form the fine-tuned model (158). The sample data (115) may include explanation samples and summarization samples.

Each of the explanation samples may include a tuple of a report, revised code, and an explanation that is identified by the system as a high-quality sample. The report may be a report from the report data (105) that has been resolved and which identifies a commit. The revised code may be code from the code data (110) that is identified in the commit associated with the report. The explanation may be text extracted from a commit that explains the code revisions made in response to a report. For example, the explanation may be a commit message from a commit identified by the report and in the commit data (108). The report may identify the commit and the commit may identify the report. In an embodiment, the quality of an explanation sample, is determined by a similarity between the report and the explanation of the explanation sample relative to other explanation samples.

Each of the summarization samples may include a tuple of programming language code and a description of the programming language code that are identified by the system as a high-quality sample. The programming language code is source code that is part of a programming language project. The description may be a textual description of the programming language code. In an embodiment, the description of the source code may be extracted from comments within the source code. In an embodiment, the quality of a summarization sample is determined by a similarity between the source code and the description of the summarization sample relative to other summarization samples.

The score data (118) is data that includes the scores of the similarities of the explanation samples and the summarization samples. A score for a sample (either an explanation sample or a summarization sample) may represent the similarity between two components in one of the samples. For example, as discussed with FIG. 2, the score of an explanation sample may identify the similarity between a report and an explanation. As discussed with FIG. 3, the score of a summarization sample may identify the similarity between a description and source code. The score data (118) may be generated from the training data (112) to identify the sample data (115).

The model data (120) is data used to store the models. Operated by the system (100). The model data (120) includes parameters, values, functions, procedures, etc., of the language model (168) and the fine-tuned model (158).

The version control system (132) is a collection of programs that manage the data (108) and the code data (110). The version control system (132) tracks changes to the code data (110) using the commit data (108) to allow collaboration between multiple users of the system (100) to develop source code projects.

The issue tracking system (135) may be a collection of programs that managed the report data (105). The issue tracking system (135) records, manages, and tracks the resolution of issues within the projects developed with the system, which may be stored in the code data (110).

The server (152) is a collection of one or more computing systems that communicate with the repository (102), the version control system (132), the issue tracking system (135), and the user devices A (180) through N (190). The server (152) may be operated to execute multiple components, including the application (155), the explanation Sample generator (160), the summarization sample generator (162), and the training application (165).

The application (155) is a component of the server (152) that includes a set of instructions (also referred to as code) that, when executed by the server (152), perform specific tasks and operations within the memory and processors of the server (152). The instructions are written in programming languages, which may include Python, JavaScript, Java, C++, C#, Ruby, etc.

The application (155) may use the fine-tuned model (158) to generate explanations from reports and revised code. The reports and revised code may be generated or identified by the system with the user devices A (180) and B (185) through N (190).

The fine-tuned model (158) is a machine learning model that has been “fine-tuned” or further trained from a pre-trained machine learning model. In an embodiment, the fine-tuned model (158) is fine-tuned from the language model (168), which may be a pre-trained model, to transfer knowledge from the language model (168) fine-tuned model (158). The fine-tuned model (158) is trained with the sample data (115), which includes high quality samples for generating explanations and summarizations. The fine-tuned model (158) includes weights and parameters, which may be stored in the model data (120), that are adjusted to better fit with the sample data (115) and improve the performance of the fine-tuned model (158) at generating explanations and summarizations as compared to the language model (168).

The machine learning models used by the system (100) (e.g., the language model (168), an explanation similarity model used in the explanation sample generator (160), a summarization similarity model used in the summarization sample generator (162), etc.) may include neural networks and may operate using one or more layers of weights that may be sequentially applied to sets of input data, which may be referred to as input vectors. For each layer of a machine learning model, the weights of the layer may be multiplied by the input vector to generate a collection of products, which may then be summed to generate an output for the layer that may be fed, as input data, to a next layer within the machine learning model. The output of the machine learning model may be the output generated from the last layer within the machine learning model. Multiple machine learning models may operate sequentially or in parallel. The output may be a vector or scalar value. The layers within the machine learning model may be different and correspond to different types of models. As an example, the layers may include layers for recurrent neural networks, convolutional neural networks, transformer models, attention layers, perceptron models, etc. Perceptron models may include one or more fully connected (also referred to as linear) layers that may convert between the different dimensions used by the inputs and the outputs of a model. Different types of machine learning algorithms may be used, including regression, decision trees, random forests, support vector machines, clustering, classifiers, principal component analysis, gradient boosting, etc.

The machine learning models may be trained by inputting training data to a machine learning model to generate training outputs that are compared to expected outputs. For supervised training, the expected outputs may be labels associated with a given input. For unsupervised learning, the expected outputs may be previous outputs from the machine learning model. The difference between the training output and the expected output may be processed with a loss function to identify updates to the weights of the layers of the model. After training on a batch of inputs, the updates identified by the loss function may be applied to the machine learning model to generate a trained machine learning model. Different algorithms may be used to calculate and apply the updates to the machine learning model, including back propagation, gradient descent, etc.

The explanation sample generator (160) is a component of the server (152). The explanation sample generator (160) includes a collection of programs to generate explanation samples from the report data (105), the commit data (108), and the code data (110), which are stored within the sample data (115).

The summarization sample generator (162) is a component of the server (152). The summarization sample generator (162) includes a collection of programs to generate summarization samples from the code data (110), which are stored in the sample data (115).

The training application (165) is a component of the server (152). The training application (165) includes a collection of programs to further train the language model (168) to form the fine-tuned model (158) from the sample data (115).

The language model (168) is a machine learning model. The language model (168) may be a language model that is pre-trained with natural language and programming language examples. The language model (168) to generate outputs that may include natural language and may include programming language in response to prompts with text that may include natural language and may include programming language.

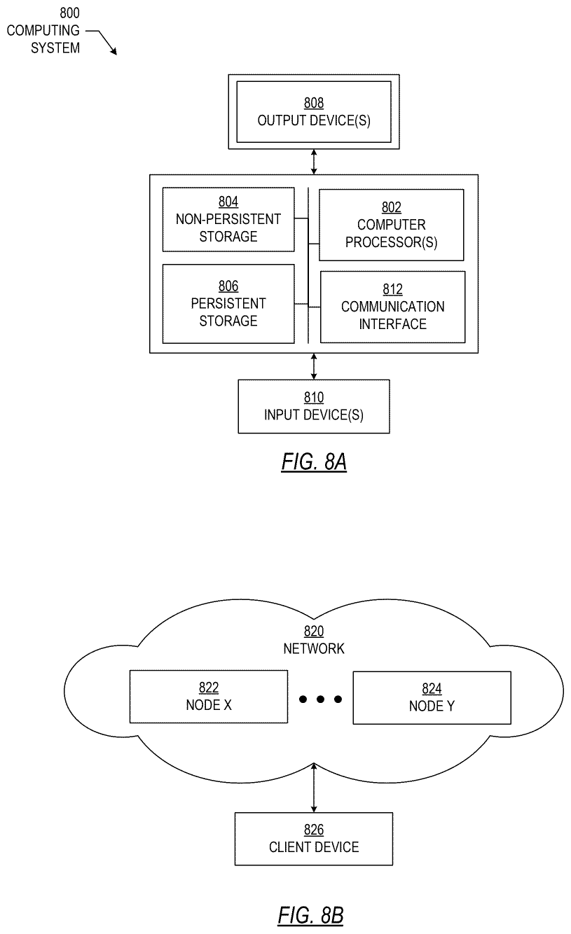

Continuing with FIG. 1, the user devices A (180) and B (185) through N (190) may interact with the server (152). The user devices A (180) and B (185) through N (190) may be computing systems in accordance with FIG. 8A and FIG. 8B. The user devices A (180) and B (185) through N (190) may include and execute the user applications A (182) and B (188) through N (192).

The user applications A (182) and B (188) through N (192) are programs that operate on the user devices A (180) and B (185) through N (190) to provide user interaction by collecting user inputs and displaying outputs in response to the user inputs. The user applications A (182) and B (188) through N (192) may include user interfaces with user interface elements to receive inputs and display outputs to the users of the system (100).

The user device A (180) may be operated by a user to interact with the application (155). For example, the user may interact with a user interface to generate revised code stored in the code data (110) using a commit stored in the commit data (108) through the version control system (132). The user may then input the report and the revised code to the application (155) to generate an explanation for the revised code.

The user device N (190) may be operated by a developer of the system (100) to adjust the application (155). The adjustments may include training the language model (168) to generate the fine-tuned model (158), which is deployed to the server (152) and used by the application (155).

Although described within the context of a client server environment with servers and user devices, aspects of the disclosure may be practiced with a single computing system and application. For example, a monolithic application may operate on a computing system (100) to perform the same functions as one or more of the applications executed by the server (152), the version control system (132), the issue tracking system (135), and the user devices A (180) and B (185) through N (190).

Turning to FIG. 2, the explanation sample generator (200) may be an embodiment of the explanation sample generator (160) of FIG. 1. The explanation sample generator (200) generates the filtered explanation samples (282) with information from the issue tracking system (202) and the version control system (212).

The issue tracking system (202) may be an embodiment of the issue tracking system (135) of FIG. 1. The issue tracking system (202) maintains the training reports (205), which may be accessed by the explanation sample generator (200). The training reports (205) describe issues (e.g., bugs) that have been resolved in the code files (215) maintained by the version control system (212).

The version control system (212) may be an embodiment of the version control system (132) of FIG. 1. The version control system (212) maintains the code files (215) and the commits (218), which may be accessible by the explanation sample generator (200).

The explanation sample generator (200) may interact with the issue tracking system (202) to access the training report (232) and interact with the version control system (212) to access the commit (252) and the training revised code (270). The explanation sample generator (200) processes the training report (232), the commit (252), and the training revised code (270) to generate the explanation sample (272) and the explanation score (268).

The training report (232) may be one of the training reports (205) that may be used to train or fine-tune a machine learning model. The training report (232) may include text that is extracted and tokenized to form the report tokens (235). The report tokens (235) may be vectorized to form the report token vectors (238). The report token vectors (238) may be combined to form the report vector (240). The report vector (240) is an input to the explanation similarity model (265).

The tokenization and vectorization of text may be performed by an embedding model that is also used by other models (e.g., the language model (168) and the fine-tuned model (158) of FIG. 1) to generate vectors from text. The embedding model may include a tokenizer that converts sequences of one or more characters of text (e.g., from the training report (232)) into individual tokens (e.g., the report tokens (235)). Each token may be an integer that uniquely identifies a sequence of text. Each token may be converted into a vector (referred to as a token vector) that includes a set of real values. The token vectors (generated from the tokens and extracted from the text) create a semantic space in which the vectors within the semantic space correlate to the meanings of the words or phrases represented by the vectors. Similar words from the text may be represented by vectors with similar values and corresponding positions within the semantic space.

Multiple vectors may be combined into a single vector that represents a collection of tokens. Algorithms used to combine multiple vectors into a single vector include average pooling, max pooling, summation, concatenation, term frequency inverse document frequency (TF-IDF) weighted pooling, distributed memory (DM) document to vector, distributed bag of words (DBOW) document to vector, mapping pre-trained sentence embeddings, attention weighted pooling, etc. As an example, average pooling may be used to average the vectors to form a single combined vector.

The commit (252) may be one of the commits (218) that may be used to train or fine-tune a machine learning model. The commit (252) may be processed to extract the training explanation (255) and to identify the training revised code (270).

The training explanation (255) may be text extracted from the commit (252). The training explanation (255) may be a commit message from the commit (252) that includes a threshold number of tokens after the text is tokenized. For example, the threshold may be 20. If the text from the commit message from the commit (252) tokenizes to a number of tokens that satisfies the threshold, then the commit (252) may be further processed to generate the explanation sample (272).

The text from the training explanation (255) may be tokenized to form the explanation tokens (258), which are tokens (sequences of one or more characters) extracted from the text of the training explanation (255). The explanation tokens (258) are vectorized to form the explanation token vectors (260). The explanation token vectors (260) are combined to form the explanation vector (262), which is a single vector that represents the training explanation (255). The explanation vector (262) is an input to the explanation similarity model (265).

The explanation similarity model (265) may be a component of the explanation sample generator (200). The explanation similarity model (265) may use a similarity function to process the report vector (240) with the explanation vector (262) to generate the explanation score (268). The similarity function may use algorithms that include cosine similarity, Euclidean distance, Manhattan distance, Minkowski distance, etc. The inverse of a distance may be used to form a similarity, e.g., a similarity may be formed by the inverse of (1 plus a distance function).

The explanation score (268) may be a value that identifies the similarity between the training report (232) and the training explanation (255). When the training report (232) and the training explanation (255) are semantically similar (as identified with the explanation similarity model (265)), the explanation score (268) may be higher as compared to the case when the training report (232) and the training explanation (255) are not semantically similar. Scores with values approaching 0 may indicate a lack of similarity and scores with values approaching 1 may indicate the presence of similarity. The explanation score (268) may be paired with the explanation sample (272).

The training revised code (270) may be the revised code identified in the commit (252) that resolves the issue identified in the training report (232). The training revised code (270) may include portions from one or more of the code files (215). For example, the training revised code (270) may include a method from one of the code files (215) that was updated to resolve the issue of the training report (232).

The explanation sample (272) may be a collection of information that may be used to fine-tune the language model (168) (of FIG. 1) and generate the fine-tuned model (158) (of FIG. 1). The explanation sample (272) includes the training report (232), the training revised code (270), and the training explanation (255). The training report (232), the training revised code (270), and the training explanation (255) may be combined to form the explanation sample (272) by concatenation. Additional tokens may be used as part of the concatenation to separate different sections. The explanation sample (272) is paired with the explanation score (268), which identifies the similarity between the training report (232) and the training explanation (255).

The explanation samples (275) may be a collection of explanation samples that includes the explanation sample (272). One of the explanation samples (275) may be generated for one of the training reports (205). One of the explanation samples (275) corresponds to one of the explanation scores (278). The explanation samples (275) are an input to the explanation filter (280).

The explanation scores (278) may be a collection of explanation scores that includes the explanation score (268). One of the explanation scores (278) may correspond to one of the training reports (205), one of the commits (218), and one or more of the code files (215). The explanation scores (278) are an input to the explanation filter (280).

The explanation filter (280) may be a component of the explanation sample generator (200). The explanation filter (280) may filter the explanation samples (275) using the explanation scores (278) to generate the filtered explanation samples (282). The explanation filter (280) may use an explanation threshold to select some of the explanation samples (275) based on corresponding explanation scores (278). The threshold may be positional, valuational, combinations thereof, etc.

A positional threshold may select samples based on the position of the sample relative to other samples when ranked by the scores of the samples. The explanation filter (280) may select the threshold number of explanation samples (275) with the highest corresponding explanation scores (278). For example, the explanation filter (280) may select the explanation samples (275) with the highest explanation scores (278).

A valuation threshold may be used to select samples based on the value of the threshold compared with the value of the scores of the samples. For example, with a threshold of 0.8, the explanation filter (280) may select each of the explanation samples (275) based on the explanation scores (278) for samples with scores that satisfy the threshold of 0.8 (e.g., greater than or equal to). The number of samples selected may fluctuate when using a valuation threshold.

The filtered explanation samples (282) may be a collection of the explanation samples (275) selected by the explanation filter (280) based on the explanation scores (278). The filtered explanation samples (282) are high quality samples that may be used to fine-tune the language model (168) (of FIG. 1) to generate the fine-tuned model (158) (of FIG. 1).

Turning to FIG. 3, the summarization sample generator (300) may be an embodiment of the summarization sample generator (162) of FIG. 1. The summarization sample generator (300) generates the filtered summarization samples (382) with information from the version control system (302).

The version control system (302) may be an embodiment of the version control system (132) of FIG. 1. The version control system (302) maintains the code files (305) which may be accessible by the summarization sample generator (300).

The summarization sample generator (300) may interact with the version control system (302) to access the code files (305). The summarization sample generator (300) processes the code file (322) to generate the summarization sample (372) and the summarization score (370).

The code file (322) may be one of the code files (305). The code file (322) may be processed to extract the source code (325) and the description (352).

The source code (325) may be programming language text extracted from the code file (322). The source code (325) may include the programming language text for a method, procedure, function, etc., from the code file (322). The source code (325) is tokenized to form the code tokens (328). The code tokens (328) are vectorized form the code token vectors (330). The code token vectors (330) are combined to form the code vector (332), which represents the source code (325).

The description (352) may be natural language text extracted from the code file (322). The description (352) may include the natural language text for comments from the code file (322). The description (352) is tokenized to form the description tokens (355), which are tokens (sequences of one or more characters) extracted from the text of the description (352). The description tokens (355) are vectorized form the description token vectors (358). The description token vectors (358) are combined to form the description vector (360), which represents the description (352).

The summarization similarity model (362) is a component of the summarization sample generator (300). The summarization similarity model (362) may use a similarity function to process the code vector (332) with the description vector (360) to generate the summarization score (370). The similarity function may use algorithms that include cosine similarity, Euclidean distance, Manhattan distance, Minkowski distance, etc. The inverse of a distance may be used to form a similarity, e.g., a similarity may be formed by the inverse of (1 plus a distance function).

The summarization score (370) may be a value that identifies the similarity between the source code (325) and the description (352). When the source code (325) and the description (352) are semantically similar (as identified with the summarization similarity model (362)), the summarization score (370) may be higher as compared to the case when the source code (325) and the description (352) are not semantically similar. Scores with values approaching 0 may indicate a lack of similarity and scores with values approaching 1 may indicate the presence of similarity. The summarization score (370) may be paired with the summarization sample (372).

The summarization sample (372) may be a collection of information that may be used to fine-tune the language model (168) (of FIG. 1) and generate the fine-tuned model (158) (of FIG. 1). The summarization sample (372) includes the source code (325) and the description (352). The source code (325) and the description (352) may be combined to form the summarization sample (372) by concatenation. Additional tokens may be used as part of the concatenation to separate different sections. The summarization sample (372) is paired with the summarization score (370), which identifies the similarity between the source code (325) and the description (352).

The summarization samples (375) may be a collection of summarization samples that includes the summarization sample (372). One of the summarization samples (375) may be generated for one section of the code file (322) (e.g., the source code (325)). One of the summarization samples (375) corresponds to one of the summarization scores (378). The summarization samples (375) are an input to the summarization filter (380).

The summarization scores (378) may be a collection of summarization scores that includes the summarization score (370). One of the summarizations scores (378) may correspond to one descriptive section of the code file (322) (e.g., the description (352)) and to one of the code sections of the code file (322) (e.g., the source code (325)). The summarization scores (378) are an input to the summarization filter (380).

The summarization filter (380) may be a component of the summarization sample generator (300). The summarization filter (380) may filter the summarization samples (375) using the summarization scores (378) to generate the filtered summarization samples (382). The summarization filter (380) may use a summarization threshold to select some of the summarization samples (375) based on corresponding summarization scores (378). The threshold may be positional, valuational, combinations thereof, etc.

The filtered summarization samples (382) may be a collection of the summarization samples (375) selected by the summarization filter (380) based on the summarization scores (378). The filtered summarization samples (382) are high quality samples that may be used to fine-tune the language model (168) (of FIG. 1) to generate the fine-tuned model (158) (of FIG. 1).

Turning to FIG. 4A, the server (400) may be the server (152) of FIG. 1. The server (400) uses the training application (410) to perform a multi-task learning of fine-tuning the language model (408) for both bug localization explanation and code summarization tasks simultaneously. This is achieved by training the language model (408) with the filtered explanation samples (402) and the filtered summarization samples (405) to generate the fine-tuned model (412). As a result, the fine-tuned model (412) may better understand the methods, functions, etc., within source code to generate better explanations. The filtered explanation samples (402) may be generated with the explanation sample generator (200) (of FIG. 2) and the filtered summarization samples (405) may be generated with the summarization sample generator (300) (of FIG. 3). The filtered explanation samples (402) and the filtered summarization samples (405) are high quality samples then improve the accuracy of the fine-tuned model (412) over the language model (408).

The training application (410) may use mask language modeling to further train the language model (408) with the filtered explanation samples (402) and the filtered summarization samples (405). Mask language modeling masks (e.g., removes while leaving a placeholder) random portions of text (e.g., characters, sequences of characters, words, etc., that are converted to tokens) within the input that is processed by the language model being trained (e.g., the language model (408)). The model being trained predicts the masked text portions of the input predictions that are compared to the original unmasked input. The error between the predictions and the original unmasked input identified with a loss function (mean squared error, mean absolute error, cross entropy loss, masked language model loss (cross entropy computed over the masked tokens), combinations thereof, etc.) are used to update the parameters and weights of the language model being trained (e.g., with back propagation, gradient descent, etc.).

Turning to FIG. 4B, the server (450) may be the server (152) of FIG. 1 and the version control system (452) may be an example of the version control system (132) of FIG. 1. The server (450) uses the fine-tuned model (480) to generate the explanation (482) from the input report (472) and the input revised code (478).

The version control system (452) manages the commits (455). The commits (455), which may be an example of the commits (218) of FIG. 2, are collections of information that track changes to programming language code.

The code selector (475) is a component of the server (450) that processes the input report (472) to identify the input revised code (478) from the commits (455). The code selector (475) may scan the input report (472) or receive user input that identifies one or more of the commits (455) as being related to the input report (472). For example, text within the input report (472), or text received from a user, may specifically identify one or more of the commits (455). The identified commits (455) may then be processed to identify the input revised code (478) from the code files (457). The code selector (475) may extract the input revised code (478) from the code files (457) after identifying the input revised code (478) within the code files (457).

The input report (472) and the input revised code (478) may be combined to form a prompt. For example, the input report (472) may be concatenated with the input revised code (478) using one or more token character encodings that may identify different sections of the prompt. A token character encoding may be a set of characters that are represented by a token. The prompt including the input report (472) and the input revised code (478) are input to the fine-tuned model (480).

The fine-tuned model (480) processes the input report (472) and the input revised code (478) to generate the explanation (482). The explanation (482) may be natural language text that describes (i.e., explains) the changes in the input revised code (478) and the relationship between the changes and the issue identified in the input report (472).

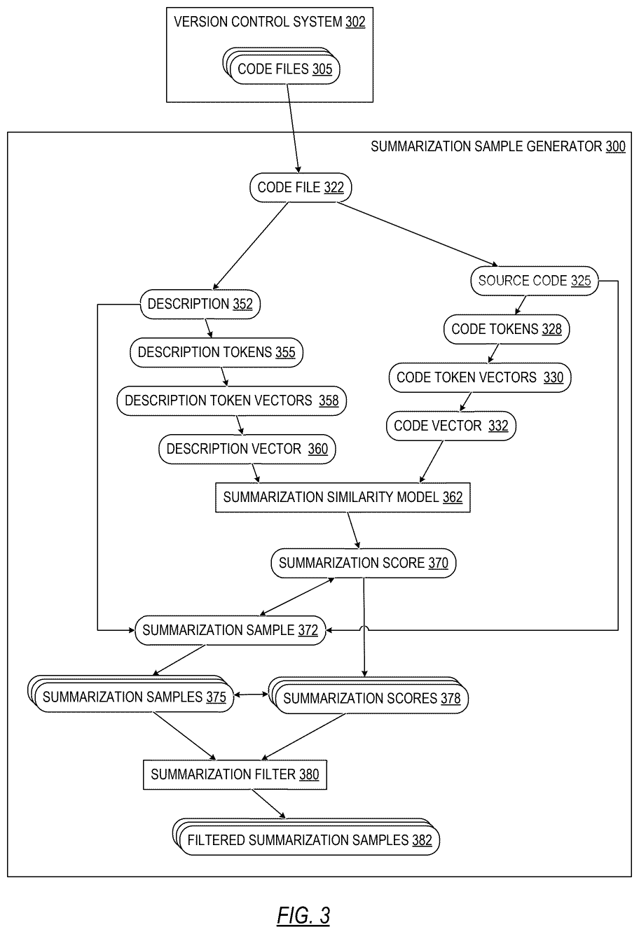

FIG. 5 shows a flowchart of a method using large language models to generate bug localization explanations enhanced by code summarization. The method of FIG. 5 may be implemented using the system of FIG. 1, and one or more of the steps may be performed on, or received at, one or more computer processors. The system may include at least one processor and an application that, when executing on the at least one processor, performs the method. A non-transitory computer readable medium may include instructions that, when executed by one or more processors, perform the method. The outputs from various components (including models, functions, procedures, programs, processors, etc.) for performing the method may be generated by applying a transformation to inputs using the components to create the outputs without using mental processes or human activities.

Turning to FIG. 5, the process (500) may be part of the application that generates samples and trains a machine learning model with the samples to fine-tune the language model. The process (500) may include multiple steps (e.g., steps (502) through (512)) that may execute on the components described in the other figures, including those of FIG. 1.

Step (502) includes executing an explanation similarity model using a training report and a training explanation to generate an explanation score for an explanation sample including the training report, training revised code, and the training explanation. The explanation similarity model may execute multiple steps to generate the explanation score.

Executing the explanation similarity model may include tokenizing the training report into report tokens. Each token may represent one or more characters from the text of the report. A character to token mapping, between the sets of characters and corresponding tokens, may be used to generate a sequence of tokens from the sequence of characters that form the training report.

Executing the explanation similarity model may include vectorizing the report tokens into report token vectors. A token to vector mapping, between tokens and corresponding vectors, may be used to generate a sequence of vectors from the sequence of tokens. An encoder model may be used to generate the token vector from the token. The encoding model may include a machine learning model with a linear layer to generate the multiple values of the vector from the single value of the token. The encoder model may take a single value input (e.g., a token value) and output a multiple value vector. Multiple layers may be used in the encoding layer.

Executing the explanation similarity model may include combining the report token vectors into a report vector. The report vector is used in calculating the explanation score. One or more algorithms may be used to combine the report token vectors into one report vector. The algorithms used may include average pooling, max pooling, summation, weighted pooling, document to vector algorithms, pre-trained sentence embeddings, attention weighted pooling, etc.

Weighted pooling may use different algorithms to weight the input.

Weighting algorithms may include term frequency inverse document frequency (TF-IDF) and attention algorithms. After being weighted, the inputs may be combined using a pooling method, e.g., average pooling, max pooling, etc.

Document to vector algorithms may use distributed memory algorithms.

Documented vector algorithms may also use distributed bag of word algorithms.

Pre-trained sentence embeddings may map an input sequence (of text, tokens, vectors, etc.) to an output embedding vector. The output embedding vector may be used as the report vector.

Different parts of the system may use the same or similar techniques for generating tokens from text, generating vectors from tokens, and combining the vectors into a single vector. For example, the same algorithms and models may be used to generate the report vector from a report as used to generate an explanation vector from a training explanation, a description vector from a description, a code vector from code, etc. The same algorithms and different models (i.e., models with different parameters) may also be used.

Executing the explanation similarity model may include tokenizing the training explanation into explanation tokens. The explanation tokens represent sets of characters from the text of the training explanation. The explanation tokens may be generated from a mapping between the tokens and sets of characters for the explanation.

Executing the explanation similarity model may include vectorizing the explanation tokens into explanation token vectors. The exploration token vectors may be generated with a mapping or an encoding model.

Executing the explanation similarity model may include combining the explanation token vectors into an explanation vector. Pooling techniques and additional algorithms may be used to combine the explanation token vectors into the explanation vector.

Executing the explanation similarity model may include calculating the explanation score between a report vector of the training report and an explanation vector of the training explanation using a similarity function using at least one of a cosine similarity, a Euclidean distance, a Manhattan distance, and a Minkowski distance. The inverse of a distance may form a similarity, e.g., inverse of (1+distance function).

Different parts of the system may use the same or similar techniques for calculating similarity between vectors. For example, the same algorithms used to generate an explanation score between a report vector and an explanation vector may be used to generate a summarization score between a description vector and a code vector. Different algorithms may also be used.

Continuing with the process (500), Step (505) includes filtering multiple explanation samples using multiple explanation scores to generate a set of filtered explanation samples. The explanation samples include the explanation sample, and the explanation scores include the explanation score.

Filtering the explanation samples may include sorting the explanation samples based on the explanation scores to generate a sorted plurality of explanation samples. With a greatest-to-least sorting, the explanation samples with corresponding explanation scores having relatively higher values may be given higher positional ranks. The numeric positional rank may be inversely proportional to the value of the explanation score. For example, the explanation sample with the positional rank of “1” (the lowest numeric value for the ranks) may correspond to the explanation score having the highest value.

Other parts of the system use the same or similar techniques. For example, the same technique may be used to sort the summarization samples.

Filtering the explanation samples may include extracting the set of filtered explanation samples from a sorted plurality of explanation samples using an explanation threshold. The explanation threshold may be a positional threshold based on the sample position within the sorted plurality relative to a cutoff position. The explanation threshold may additionally or alternatively be a valuational threshold based on the explanation score relative to a cutoff value of the explanation score. The same or similar techniques may be used to filter the summarization samples.

Continuing with the process (500), Step (508) includes executing a summarization similarity model using source code and a description to generate a summarization score for a summarization sample including the source code and the description. The summarization similarity model may execute multiple steps to generate the summarization score.

Executing the summarization similarity model may include tokenizing the source code into code tokens. A tokenizer may map sets of one more characters from the source code to the code tokens.

Executing the summarization similarity model may include vectorizing the code tokens into code token vectors. An encoder model (also referred to as a vectorizer) may generate the token vectors from the code tokens. Generation may be performed by a using a mapping between tokens and vectors or by calculating the vector from the token.

Executing the summarization similarity model may include combining the code token vectors into a code vector. The code vector represents the sequence of token vectors, which represents the sequence of characters from the source code. The combination may be performed by the techniques described above which may include weighting and pooling the input vectors (e.g., the code token vectors) to generate the output vector (e.g., the code vector).

Executing the summarization similarity model may include tokenizing the description into description tokens. A tokenizer may map sets of one more characters from the description to the description tokens.

Executing the summarization similarity model may include vectorizing the description tokens into description token vectors. An encoder model may generate the description vectors from the description tokens.

Executing the summarization similarity model may include combining the description token vectors into a description vector. The description vector represents the sequence of description token vectors, which represent the text from the description. The combination may be performed by the techniques described above which may include weighting and pooling the input vectors (e.g., the description token vectors) to generate the output vector (e.g., the description vector).

Executing the summarization similarity model may include calculating the summarization score between the code vector of the source code and the description vector of the description. The calculation may be performed using a similarity function using at least one of a cosine similarity, a Euclidean distance, a Manhattan distance, and a Minkowski distance.

Continuing with the process (500), Step (510) includes filtering multiple summarization samples using multiple summarization scores to generate a set of filtered summarization samples. The summarization samples includes the summarization sample and the summarization scores includes the summarization score.

Filtering the summarization samples may include sorting the summarization samples based on the summarization scores to generate a sorted plurality of summarization samples. The sorting may be greatest to least so that the summarization sample corresponding to the highest summarization score is sorted as the highest ranking summarization sample, which may have the lowest positional value (e.g. “1”).

Filtering the summarization samples may include extracting the set of filtered summarization samples from the sorted plurality of summarization samples using a summarization threshold. The summarization threshold may be positional or valuational.

Continuing with the process (500), Step (512) includes training a model using the set of filtered explanation samples and the set of filtered summarization samples to generate the fine-tuned model. The set of filtered explanation samples includes the explanation sample comprising the training report, the training revised code, and the training explanation. The training may include multiple steps.

Training the fine-tuned model may include executing the language model using the set of filtered explanation samples and the set of filtered summarization samples to generate training outputs. The execution of the language model may be performed using masked versions of the input samples (e.g., the filtered explanation samples and the filtered summarization samples). The language model may output predictions with output values for the masked values from the masked versions of the input samples.

Training the fine-tuned model may include determining error between the training outputs and expected outputs. The training outputs may be the output values for the mask values and the expected outputs may be the original unmasked values from the input.

Training the fine-tuned model may include generating updated parameters from the error. The updated parameters may be for the language model that, when incorporated into the language model, form the fine-tune model having improved accuracy.

Training the fine-tuned model may include combining the updated parameters with the language model to form the fine-tuned model. The language model may be a pre-trained model and the updated parameters may be combined with the pre-trained parameters. The combination may be performed by adding the updated parameter values to the pre-trained parameter values.

The process (500) may include executing the fine-tuned model using an input report and input revised code to generate an explanation. After the language model is trained to be fine-tuned and form the fine-tuned model, the fine-tuned model may be used to generate explanations for reports and revised code. Text extracted from an input report may be combined with text extracted from input revised code into a prompt that is input to the fine-tuned model. The text may be combined using token character encodings to separate different portions of the prompt. The fine-tuned model may process the prompt to generate the text of an explanation as an output.

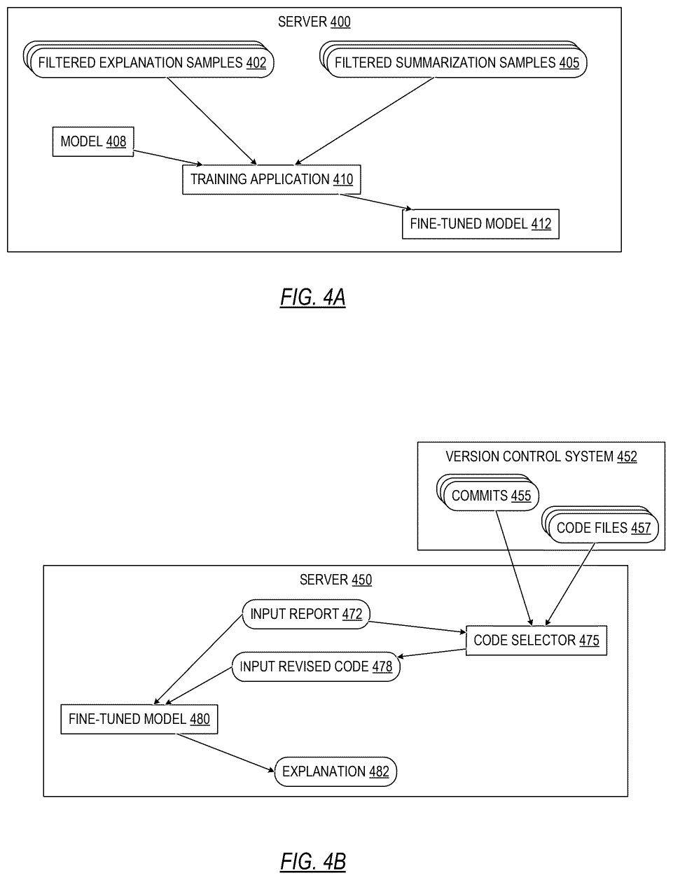

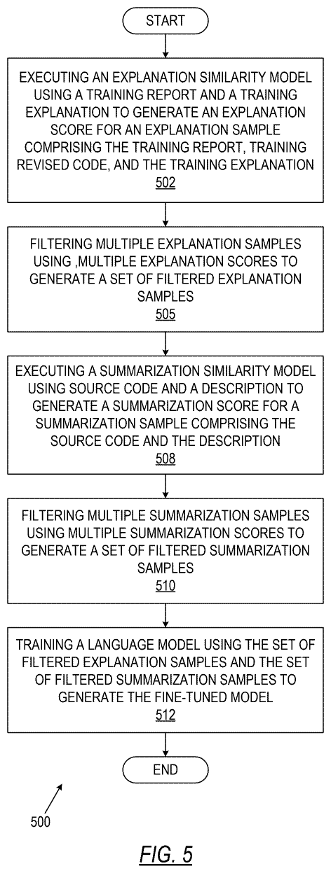

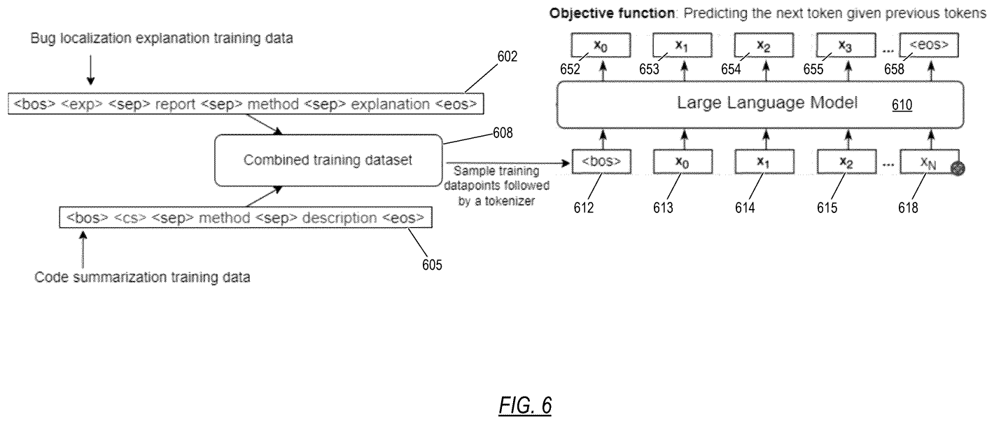

Turning to FIG. 6, an example of fine-tuning a language model is illustrated. The explanation sample (602) and the summarization sample (605) are two high quality samples that are generated and stored as sample data to the combined training dataset (608). One of the samples from the training data set may be processed to form the sequence of input tokens (612) through (618) that are input to the language model (610), which may be a large language model utilizing transformer and attention machine learning algorithms. The language model (610) processes the sequence of input tokens (612) through (618) to generate the sequence of output tokens (652) through (658). The training process may be autoregressive to predict the next token (e.g., the token (658)) from the sequence of input tokens (612) through (618).

The explanation sample (602) is illustrated with additional token character encodings that provide additional context to the language model (610). A token character encoding is the character encoding of a token generated by a tokenizer into which the explanation sample (602) may be input. The token character encoding may be mapped to a certain token. The token character encoding “<bos>” may be for a token that identifies the beginning of a sentence.

The token character encoding “<bos>” may be for a token that identifies the beginning of a sentence in a sample. The token character encoding “<exp>” may be for a token that identifies the sample being processed as an explanation sample. The token character encoding “<sep>” may be for a token that identifies a split between different sections within the sample. The token character encoding “<eos>” may be for a token that identifies the end of a sentence (which may correlate to the end of the sample).

The character sequence “report” may be replaced with natural language text from a report. The character sequence “method” (in the explanation sample (602)) may be replaced with programming language text (which may include natural language comments) from revised code that resolved the issue from the report. The character sequence “explanation” may be replaced with text from a commit message that may explain the code in the “method” and how the bug in the “report” is resolved.

The summarization sample (605) is also illustrated with additional token character encodings for additional context. The additional token character encodings in the summarization sample (605) may include some of the token character encodings used in the explanation sample (602). The token character encoding “<cs>” may be for a token that identifies the sample being processed as a code summarization sample.

The character sequence “method” (in the summarization sample (605)) may be replaced with programming language text (which may have comments removed) from source code from a project maintained with a version control system. The character sequence “description” may be replaced with natural language text, which may be extracted from the comments of the programming language text in the source code.

The training process may, for each token of the input, predict a subsequent token. For example, for the input tokens (612), (613), (614), (615), and (618), the output tokens (652), (653), (654), (655), and (658) are predicted by the language model (610). The input tokens (613), (614), and (615) may have the same value as the output tokens (652), (653), and (654), effectively being shifted one slot in the sequence.

Turning to FIG. 7, an example of using a fine-tuned model is illustrated. The report (710) describes an issue with a programming project. The revised code (712) identifies the code that was revised (in the “BEFORE” section) and how the code revised (in the “AFTER” section). The report (710) and the revised code (712) are combined and input to the fine-tuned model. Additional token character encodings may be included before or after the report (710) and the revised code (712) to make the combination of the report (710) with the revised code (712) into a prompt suitable for the fine-tuned model.

The fine-tuned model processes the prompt, which includes the report (710) and the revised code (712) and outputs the explanation (715). The explanation is (715) describes the resolution of the issue described in the report (710) using the revised code (712).

Embodiments may be implemented on a special purpose computing system specifically designed to achieve the improved technological result. Turning to FIGS. 8A and 8B, the special purpose computing system (800) may include one or more computer processors (802), non-persistent storage (804), persistent storage (806), a communication interface (812) (e.g., Bluetooth interface, infrared interface, network interface, optical interface, etc.), and numerous other elements and functionalities that implement the features and elements of the disclosure. The computer processor(s) (802) may be an integrated circuit for processing instructions. The computer processor(s) may be one or more cores or micro-cores of a processor. The computer processor(s) (802) includes one or more processors. The one or more processors may include a central processing unit (CPU), a graphics processing unit (GPU), a tensor processing unit (TPU), combinations thereof, etc.

The input device(s) (810) may include a touchscreen, keyboard, mouse, microphone, touchpad, electronic pen, or any other type of input device. The input device(s) (810) may receive inputs from a user that are responsive to data and messages presented by the output device(s) (808). The inputs may include text input, audio input, video input, etc., which may be processed and transmitted by the computing system (800) in accordance with the disclosure. The communication interface (812) may include an integrated circuit for connecting the computing system (800) to a network (not shown) (e.g., a local area network (LAN), a wide area network (WAN) such as the Internet, mobile network, or any other type of network), and/or to another device, such as another computing device.

Further, the output device(s) (808) may include a display device, a printer, external storage, or any other output device. One or more of the output device(s) (808) may be the same or different from the input device(s) (810). The input device(s) (810) and the output device(s) (808) may be locally or remotely connected to the computer processor(s) (802). Many different types of computing systems exist, and the aforementioned input device(s) (810) and output device(s) (808) may take other forms. The output device(s) (808) may display data and messages that are transmitted and received by the computing system (800). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments, which may include transmitting, receiving, presenting, and displaying data and messages described in the other figures of the disclosure.

The computing system (800) in FIG. 8A may be connected to or be a part of a network. For example, as shown in FIG. 8B, the network (820) may include multiple nodes (e.g., node X (822) and node Y (824)). Each node may correspond to a computing system, such as the computing system (800) shown in FIG. 8A, or a group of nodes combined may correspond to the computing system (800) shown in FIG. 8A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (800) may be located at a remote location and connected to the other elements over a network.

The nodes (e.g., node X (822) and node Y (824)) in the network (820) may be configured to provide services for a client device (826), including receiving requests and transmitting responses to the client device (826). For example, the nodes may be part of a cloud computing system. The client device (826) may be a computing system, such as the computing system (800) shown in FIG. 8A. Further, the client device (826) may include and/or perform all or a portion of one or more embodiments of the disclosure.

The computing system (800) of FIG. 8A may include functionality to present raw and/or processed data, such as results of comparisons and other processing. For example, presenting data may be accomplished through various presenting methods. Specifically, data may be presented by being displayed in a user interface, transmitted to a different computing system, and stored. The user interface may include a graphical user interface (GUI) that displays information on a display device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be temporary, permanent, or semi-permanent communication channel between two entities.

The various descriptions of the figures may be combined and may include or be included within the features described in the other figures of the application. The various elements, systems, components, and steps shown in the figures may be omitted, repeated, combined, and/or altered as shown from the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements, nor to limit any element to being a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, or is an “inclusive or” and, as such includes “and.” Further, items joined by an “or” may include any combination of the items with any number of each item unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above may be devised which do not depart from the scope of the claims as disclosed herein. Accordingly, the scope should be limited only by the attached claims.

What is claimed is:

1. A method comprising:
executing an explanation similarity model using a training report and a training explanation to generate an explanation score for an explanation sample comprising the training report, training revised code, and the training explanation;
filtering a plurality of explanation samples using a plurality of explanation scores to generate a set of filtered explanation samples, wherein the plurality of explanation samples comprises the explanation sample and the plurality of explanation scores comprises the explanation score;
executing a summarization similarity model using source code and a description to generate a summarization score for a summarization sample comprising the source code and the description;
filtering a plurality of summarization samples using a plurality of summarization scores to generate a set of filtered summarization samples, wherein the plurality of summarization samples comprises the summarization sample and the plurality of summarization scores comprises the summarization score; and
training a language model using the set of filtered explanation samples and the set of filtered summarization samples to generate a fine-tuned model, wherein the set of filtered explanation samples comprises the explanation sample comprising the training report, the training revised code, and the training explanation.

2. The method of claim 1, further comprising:
executing the fine-tuned model using an input report and input revised code to generate an explanation.

3. The method of claim 1, wherein executing the explanation similarity model comprises:
tokenizing the training report into a plurality of report tokens; and
vectorizing the plurality of report tokens into a plurality of report token vectors; and
combining the plurality of report token vectors into a report vector,
wherein the report vector is used in calculating the explanation score.

4. The method of claim 1, wherein executing the explanation similarity model comprises:
tokenizing the training explanation into a plurality of explanation tokens;
vectorizing the plurality of explanation tokens into a plurality of explanation token vectors; and
combining the plurality of explanation token vectors into an explanation vector.

5. The method of claim 1, wherein executing the explanation similarity model comprises:
calculating the explanation score between a report vector of the training report and an explanation vector of the training explanation using a similarity function using at least one of a cosine similarity, a Euclidean distance, a Manhattan distance, and a Minkowski distance.

6. The method of claim 1, wherein filtering the plurality of explanation samples comprises:
sorting the plurality of explanation samples based on the plurality of explanation scores to generate a sorted plurality of explanation samples.

7. The method of claim 6, wherein filtering the plurality of explanation samples comprises:
extracting the set of filtered explanation samples from the sorted plurality of explanation samples using an explanation threshold.

8. The method of claim 1, wherein executing the summarization similarity model comprises:
tokenizing the source code into a plurality of code tokens;
vectorizing the plurality of code tokens into a plurality of code token vectors;
combining the plurality of code token vectors into a code vector;
tokenizing the description into a plurality of description tokens;
vectorizing the plurality of description tokens into a plurality of description token vectors;
combining the plurality of description token vectors into a description vector; and
calculating the summarization score between the code vector of the source code and the description vector of the description using a similarity function using at least one of a cosine similarity, a Euclidean distance, a Manhattan distance, and a Minkowski distance.

9. The method of claim 1, wherein filtering the plurality of summarization samples comprises:
sorting the plurality of summarization samples based on the plurality of summarization scores to generate a sorted plurality of summarization samples; and
extracting the set of filtered summarization samples from the sorted plurality of summarization samples using a summarization threshold.

10. The method of claim 1, wherein training the fine-tuned model comprises:
executing the language model using the set of filtered explanation samples and the set of filtered summarization samples to generate a plurality of training outputs;
determining an error between the plurality of training outputs and a plurality of expected outputs;
generating a plurality of updated parameters from the error; and
combining the plurality of updated parameters with the language model to form the fine-tuned model.

11. A system comprising
at least one processor; and
an application that, when executing on the at least one processor, performs operations comprising:
executing an explanation similarity model using a training report and a training explanation to generate an explanation score for an explanation sample comprising the training report, training revised code, and the training explanation,
filtering a plurality of explanation samples using a plurality of explanation scores to generate a set of filtered explanation samples, wherein the plurality of explanation samples comprises the explanation sample and the plurality of explanation scores comprises the explanation score,
executing a summarization similarity model using source code and a description to generate a summarization score for a summarization sample comprising the source code and the description,
filtering a plurality of summarization samples using a plurality of summarization scores to generate a set of filtered summarization samples, wherein the plurality of summarization samples comprises the summarization sample and the plurality of summarization scores comprises the summarization score, and
training a language model using the set of filtered explanation samples and the set of filtered summarization samples to generate a fine-tuned model, wherein the set of filtered explanation samples comprises the explanation sample comprising the training report, the training revised code, and the training explanation.

12. The system of claim 11, wherein the application performs operations further comprising:
executing the fine-tuned model using an input report and input revised code to generate an explanation.

13. The system of claim 11, wherein executing the explanation similarity model comprises:
tokenizing the training report into a plurality of report tokens;
vectorizing the plurality of report tokens into a plurality of report token vectors; and
combining the plurality of report token vectors into a report vector, wherein the report vector is used in calculating the explanation score.

14. The system of claim 11, wherein executing the explanation similarity model comprises:
tokenizing the training explanation into a plurality of explanation tokens;
vectorizing the plurality of explanation tokens into a plurality of explanation token vectors; and
combining the explanation token vectors into an explanation vector.

15. The system of claim 11, wherein executing the explanation similarity model comprises:
calculating the explanation score between a report vector of the training report and an explanation vector of the training explanation using a similarity function using at least one of a cosine similarity, a Euclidean distance, a Manhattan distance, and a Minkowski distance.

16. The system of claim 11, wherein filtering the plurality of explanation samples comprises:
sorting the plurality of explanation samples based on the plurality of explanation scores to generate a sorted plurality of explanation samples.

17. The system of claim 11, wherein filtering the plurality of explanation samples comprises:
extracting the set of filtered explanation samples from a sorted plurality of explanation samples using an explanation threshold.

18. The system of claim 11, wherein executing the summarization similarity model comprises:
tokenizing the source code into a plurality of code tokens;
vectorizing the plurality of code tokens into a plurality of code token vectors;
combining the plurality of code token vectors into a code vector;
tokenizing the description into a plurality of description tokens;
vectorizing the plurality of description tokens into a plurality of description token vectors;
combining the plurality of description token vectors into a description vector; and
calculating the summarization score between the code vector of the source code and the description vector of the description using a similarity function using at least one of a cosine similarity, a Euclidean distance, a Manhattan distance, and a Minkowski distance.

19. The system of claim 11, wherein filtering the plurality of summarization samples comprises:
sorting the plurality of summarization samples based on the plurality of summarization scores to generate a sorted plurality of summarization samples; and
extracting the set of filtered summarization samples from the sorted plurality of summarization samples using a summarization threshold.

20. A non-transitory computer readable medium comprising instructions executable by at least one processor to perform:
executing an explanation similarity model using a training report and a training explanation to generate an explanation score for an explanation sample comprising the training report, training revised code, and the training explanation;
filtering a plurality of explanation samples using a plurality of explanation scores to generate a set of filtered explanation samples, wherein the plurality of explanation samples comprises the explanation sample and the plurality of explanation scores comprises the explanation score;
executing a summarization similarity model using source code and a description to generate a summarization score for a summarization sample comprising the source code and the description;
filtering a plurality of summarization samples using a plurality of summarization scores to generate a set of filtered summarization samples, wherein the plurality of summarization samples comprises the summarization sample and the plurality of summarization scores comprises the summarization score; and
training a language model using the set of filtered explanation samples and the set of filtered summarization samples to generate the fine-tuned model, wherein the set of filtered explanation samples comprises the explanation sample comprising the training report, the training revised code, and the training explanation.
